(19) United States
(12) Patent Application Publication
(10) Pub. No.: US 2025/0235785 A1
(43) Pub. Date: Jul. 24, 2025

(54) INFORMATION PROCESSING METHOD AND COMPUTERIZED SYSTEM FOR BATTLE GAME, AND COMPUTER READABLE MEDIUM

(71) Applicant: Yidian Lingxi Information Technology (Guangzhou) Co. Ltd., Guangdong (CN)

(72) Inventors: Huanhao Lu, Guangdong (CN); Tong Su, Guangdong (CN); Zeyu Xiao, Guangdong (CN); Ke Yang, Guangdong (CN)

(73) Assignee: Yidian Lingxi Information Technology (Guangzhou) Co., Ltd., Guangdong (CN)

(21) Appl. No.: 19/028,232

(22) Filed: Jan. 17, 2025

(30) Foreign Application Priority Data
Jan. 22, 2024 (CN) 202410091663.2

(51) Int. Cl. A63F 13/5372; A63F 13/56

(52) U.S. Cl. CPC A63F 13/5372; A63F 13/56

(57) ABSTRACT

The present disclosure provides an information processing method and apparatus for a battle game, and an electronic device. The method includes: determining, by a processor, a first team to which a first user belongs according to a team selection operation of the user in a first camp to which the first user belongs; generating, by the processor, a first battle scene for displaying on an interface; and displaying, on the interface, the first battle scene.

### CROSS-REFERENCE TO RELATED APPLICATION

This application claims priority to Chinese Patent Application No. 202410091663.2, filed on Jan. 22, 2024, which is hereby incorporated by reference in its entirety.

### TECHNICAL FIELD

The present disclosure relates to the technical field of gaming, and particularly, to an information processing method for implementation by a computer that executes a battle game, a computerized system for providing information processing in a battle game, and a non-transitory computer-readable medium.

### BACKGROUND

With the rapid development of the gaming industry, the number of battle-type games has been increasing. In some strategy games, the two opposing camps can capture plots within the game map to gain game resources, rewards, or unlock missions. However, sequentially occupying plots adjacent to their starting plots results in reduced strategic depth and negatively impacts the user experience.

### SUMMARY

One objective of an embodiment of the present disclosure is to provide a new technical solution of an information processing method for implementation by a computer that executes a battle game.

According to a first aspect of the present disclosure, an information processing method for implementation by a computer that executes a battle game is provided, the method including:
determining a first team to which a user belongs according to a team selection operation of the user in a first camp to which the user belongs; wherein the first camp includes both the first team and a second team which correspond to different battle configurations, and the first camp comprises a plurality of users; and
showing on an interface a first battle scene that the user enters; wherein the first battle scene includes a first plot which can be occupied by the first team and a second plot which can be occupied by the second team, the second plot being adjacent to a friendly plot, and the first plot being spaced from the friendly plot by at least one plot; wherein the friendly plot is a plot occupied by the first camp, and users belonging to the first team control virtual characters to attack and occupy the first plot.

Optionally, after “showing on an interface a first battle scene that the user enters”, the method further includes:
according to a first plot that the first team is instructed to attack, the first battle scene displays the instructed first plot as an attack target of the user; and
according to a battle joining operation of the user directed at the attack target, showing on the interface a second battle scene where the first team engages in battle with at least one third team from a second camp.

Optionally, after “displaying on the interface a second battle scene where the first team engages in battle with at least one third team from a second camp”, the method further includes:
according to the first team being determined as a winner in the second battle scene, determining that the first team has occupied the first plot which was the attack target; and
in the first battle scene, providing an exclusive designation for the first plot now occupied by the first team.

Optionally, after “showing on an interface a first battle scene that the user enters”, the method further includes:
displaying a battle result of the second team attacking a second plot; and
if the battle result indicates that the second team has won, displaying the second plot as now occupied by the first camp.

Optionally, after “showing on an interface a first battle scene that the user enters”, the method further includes:
displaying a battle result of a third team from the second camp attacking a second plot that is already occupied by the first camp; and
if the battle result indicates that the third team has won, displaying the second plot as now occupied by the second camp.

Optionally, the first battle scene also includes special plots that cannot be occupied by

the first camp, and the special plots include a plot that serves as a spawn point for the second camp and a plot that is under war-free protection.

Optionally, the first battle scene also shows plot information about each of the first plot and the second plot; wherein the plot information includes resource information and building information;
wherein the resource information includes a resource type and a resource quantity set for a plot; and the building information includes a building level and a building name set for a plot.

According to a second aspect of the present disclosure, a computerized system for providing information processing in a battle game is further provided, including: a memory, configured for storing a computer program; and a processor, configured for executing operations under control of the computer program, the operations comprising:
determining a first team to which a user belongs according to a team selection operation of the user in a first camp to which the user belongs; wherein the first camp includes both the first team and a second team which correspond to different battle configurations, and the first camp comprises a plurality of users; and
showing on an interface a first battle scene that the user enters; wherein the first battle scene includes a first plot which can be occupied by the first team and a second plot which can be occupied by the second team, the second plot being adjacent to a friendly plot, and the first plot being spaced from the friendly plot by at least one plot; wherein the friendly plot is a plot occupied by the first camp, and users belonging to the first team control virtual characters to attack and occupy the first plot.

According to a third aspect of the present disclosure, further provided is non-transitory computer-readable medium storing instructions, when executed by a processor, cause the processor to perform a method for information processing in a battle game, the method comprising: determining a first team to which a user belongs according to a team selection operation of the user in a first camp to which the user belongs; wherein the first camp comprises both the first team and a second team which correspond to different battle configurations, and the first camp comprises a plurality of users; and showing on an interface a first battle scene that the user enters; wherein the first battle scene comprises a first plot which can be occupied by the first team and a second plot which can be occupied by the second team, the second plot being adjacent to a friendly plot, and the first plot being spaced from the friendly plot by at least one plot; wherein the friendly plot is a plot occupied by the first camp, and users belonging to the first team control virtual characters to attack and occupy the first plot.

One beneficial effect of the embodiments of the present disclosure is that: after a user selects the first team of the first camp, in the first battle scene shown on the interface, the user can view the first plot that the first team, to which he/she belongs, can occupy and the second plot that the other second team can occupy. The first team to which the user belongs can occupy the first plot, allowing rewards for all users in the first camp to be determined based on the overall occupancy of plots by both teams. This necessitates the rational allocation of members between the first team and the second team during the occupation process of the first camp, thereby enhancing the game's playability and increasing user enjoyment.

The features of the embodiments of the present specification and their advantages will become clear through the following detailed description of the exemplary embodiments of the present specification with reference to the accompanying drawings.

### BRIEF DESCRIPTION OF THE DRAWINGS

The accompanying drawings, which are incorporated in and constitute a part of the specification, illustrate embodiments of present disclosure and, together with the description thereof, serve to explain the principles of the disclosure.

FIG. 1 illustrates a schematic diagram of a hardware structure of an electronic device that can be used to implement an information processing method for a battle game according to an embodiment of the present disclosure;

FIG. 2A and FIG. 2B illustrates a flowchart of the information processing method for a battle game according to some embodiments;

FIG. 3 illustrates a schematic diagram of a teaming list according to some embodiments;

FIG. 4 illustrates a schematic diagram of a first battle scene according to some embodiments;

FIG. 5 illustrates a schematic diagram of a second battle scene according to some embodiments;

FIG. 6 illustrates a structural schematic diagram of the information processing apparatus for a battle game according to some embodiments;

FIG. 7 illustrates a schematic diagram of the hardware structure of the electronic device according to some embodiments.

FIG. 8 illustrates a schematic diagram of an operating environment of a computerized system for providing information processing in a battle game according to some embodiments.

### DETAILED DESCRIPTION

Various exemplary embodiments of the present specification will now be described in detail with reference to the accompanying drawings.

The following description of at least one exemplary embodiment is in fact merely illustrative and is in no way intended as a limitation to the present disclosure and its application or use.

It should be noted that similar reference numerals and letters represent similar items in the accompanying drawings below. Therefore, once an item is defined in one drawing, it is unnecessary to further discuss the item in the subsequent drawings.

It should be noted that all actions to obtain signals, information or data in embodiments of this specification are performed in compliance with the corresponding data protection regulations and policies of the country in which they are located, and with authorization from owners of the corresponding devices.

The embodiments of the present disclosure provide a new information processing solution for a battle game, allowing users to join different teams within their camp. This enables different teams within the same camp to correspond to different battle configurations, enabling users to occupy corresponding plots based on the battle configuration of their team. This approach enriches the strategic depth of the game and enhances user enjoyment.

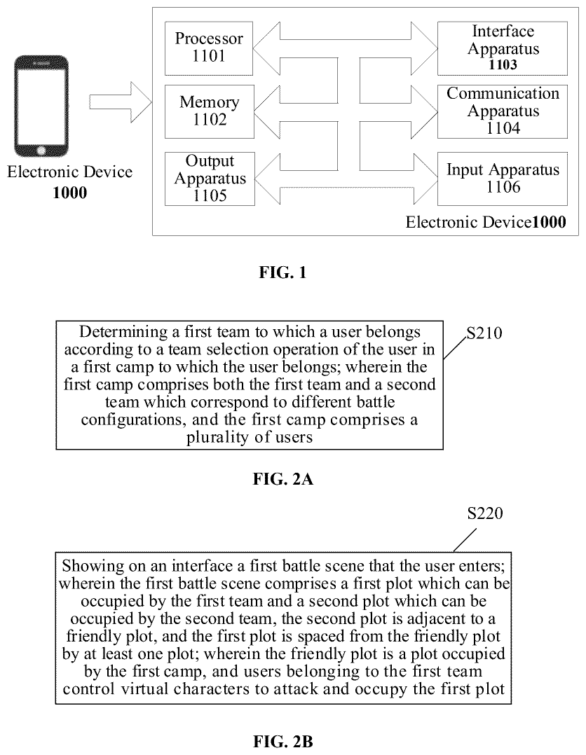

FIG. 1 illustrates a schematic diagram of a hardware structure of an electronic device that can be used to implement an information processing method for a battle game according to an embodiment of the present disclosure.

The electronic device 1000 is a device capable of running games. The game can be a locally installed application on the electronic device, or it can be a web-based game, a light application, a mini-program, etc., which is not limited herein. The electronic device 1000 can be a mobile phone, a tablet computer, a PC, etc., which is not limited herein.

As shown in FIG. 1, the electronic device 1000 may include a processor 1101, a memory 1102, an interface apparatus 1103, a communication apparatus 1104, an output apparatus 1105, an input apparatus 1106, and so on. The hardware configuration depicted in FIG. 1 is illustrative only and is not intended to limit the present disclosure, its applications, or uses.

The processor 1101 executes computer programs that can be written using instruction sets for architectures such as x86, Arm, RISC, MIPS, SSE, among others. The memory 1102 includes, for example, ROM (Read-Only Memory), RAM (Random Access Memory), non-volatile storage such as hard drives, etc. The interface apparatus 1103 includes, for example, a USB interface, a network cable interface, an earphone interface, etc. The communication apparatus 1104 supports both wired and wireless communications, and can include at least one short-range communication module, such as any module for short-range wireless communication based on short-range wireless communication protocols such as Hilink protocol, WiFi (IEEE 802.11 protocol), Mesh, Bluetooth, ZigBee, Thread, Z-Wave, NFC, UWB, LiFi, etc. The communication apparatus 1104 can also include a remote communication module, such as any module for WLAN, GPRS, 2G/3G/4G/5G remote communication. The output devices 1105, for example, can include LCD screens or touchscreens, speakers, etc. The input devices 1106, for example, can include touchscreens, keyboards, microphones, various sensors, etc.

In the present embodiment, the memory 1102 of the electronic device 1000 is configured for storing a computer program that controls the operation of the processor 1101 to perform the information processing method for a battle game according to any embodiment of the present disclosure.

Next, taking the electronic device 1000 illustrated in FIG. 1 as an implementation subject, various embodiments of information processing method for a battle game are illustrated.

### First Embodiment

FIGS. 2A and 2B illustrate the information processing method for a battle game according to some embodiments, which may include the following steps S210 and S220:
Step S210: determining a first team to which a user belongs according to a team selection operation of the user in a first camp to which the user belongs; wherein the first camp comprises both the first team and a second team which correspond to different battle configurations, and the first camp comprises a plurality of users.

In the present embodiment, the term “user” refers to a player of the game.

In some examples, a virtual character of the user must meet certain conditions to enable the team selection operation. For example, the level of the virtual character must be greater than or equal to a specific level threshold, the number of owned virtual characters must be greater than or equal to a quantity threshold, or the user's camp level within the first camp must be greater than or equal to a specific camp level threshold, etc.

In the present embodiment, the user of the first camp can be all users in the same team or group within the same server, all users in the same server, or all users in the same range. For example, all users within servers from range 300 to 399 constitute one first camp, which is not limited herein.

In the present embodiment, “first camp” is a relative concept. For instance, if all users from Server A and all users from Server B engage in battle as opposing camps, then from the perspective of a user A1 in Server A, all players in Server A are considered the first camp, whereas from the perspective of a user B1 in Server B, all players in Server A are considered the second camp.

In the present embodiment, users within the first camp can organize their own teams. One or more users selected by the first camp can act as the administrator of the first camp who can organize different teams, or the system can randomly assign users to teams, which is not limited herein.

In the present embodiment, the first and second teams may be the same or different in terms of the number of teams and the number of members in each team, which is not limited herein. For example, in the first camp M, there could be one first team consisting of 5 members and two second teams, with each of the two second teams consisting of 10 members.

In the present embodiment, different battle configurations correspond to battles of different teams within the first camp. Specifically, the first team may correspond to Battle Configuration 1, and the second team may correspond to Battle Configuration 2, wherein the Battle Configuration 1 differs from the Battle Configuration 2. For example, the Battle Configuration 1 for the first team allows direct capture of a plot around the spawn point for the second camp, whereas the Battle Configuration 2 for the second team allows capture of a plot adjacent to the second camp. Another example is that the Battle Configuration 1 for the first team allows capture of a plot with odd horizontal coordinates in the game map, while the Battle Configuration 2 for the second team allows capture of a plot with even horizontal coordinates in the game map. Yet another example is that the Battle Configuration 1 for the first team involves attacking a specific number of plots followed by the second team attacking a specific number of plots, after which the first team resumes attacking. The Battle Configuration 2 for the second team involves waiting until the first team has attacked a specific number of plots before they themselves attack a specific number of plots. The number of plots attacked by the first team may be the same or different from the number attacked by the second team, which is not limited herein.

In the present embodiment, plots can be represented by models of any buildings or natural landscapes, such as castles, fortresses, or caves, which is not limited herein.

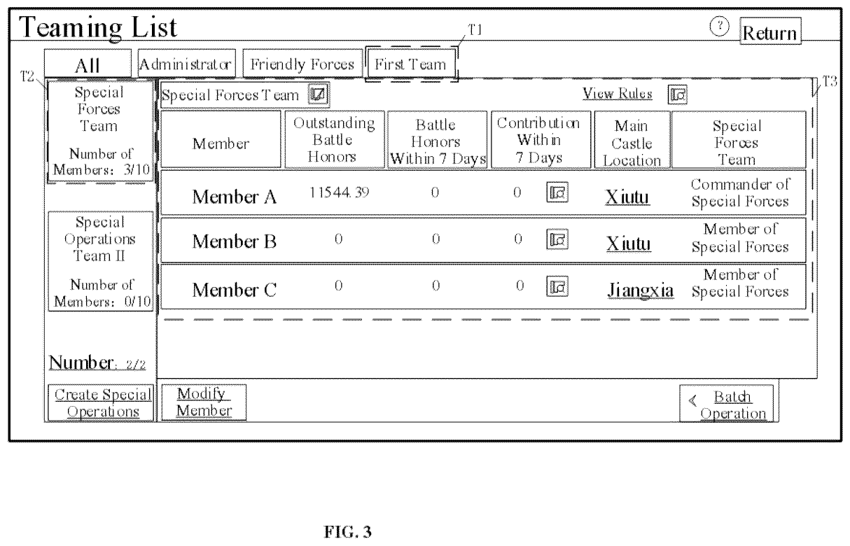

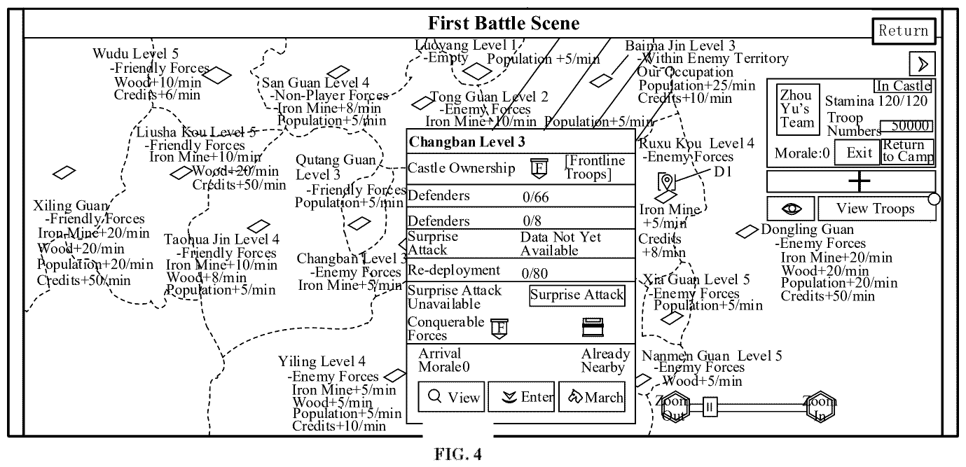

In some examples, if the user is an administrator of the first camp, he or she may click the teaming control provided on the interface, causing the teaming list as shown in FIG. 3 to pop up on the interface. Then the user may perform operations such as creating teams or editing teams in this teaming list. For example, after the user clicks on the display option T1 corresponding to the first team, he or she then clicks on the member option T2 for the first team, and the teaming list finally shows detailed information T3 about each user in the “Special forces team”.

In some examples, if the user is not an administrator of the first camp, he or she may click the teaming control provided on the interface, causing a corresponding teaming list to pop up on the interface, and the teaming list may show both the first team and the second team for the user to apply to join. After applying to join a team and receiving approval from the administrator, the user can join that team and engage in a battle as a member of that team.
Step S220: showing on an interface a first battle scene that the user enters; wherein the first battle scene comprises a first plot which can be occupied by the first team and a second plot which can be occupied by the second team, the second plot being adjacent to a friendly plot, and the first plot being spaced from the friendly plot by at least one plot; wherein the friendly plot is a plot occupied by the first camp, and users belonging to the first team control virtual characters to attack and occupy the first plot.

In the present embodiment, the first battle scene that the user enters may be one of several different game maps or a unique game map, which is not limited herein.

In the present embodiment, the first battle scene is composed of a plurality of plots. Additionally, the first battle scene may include one or more different plots designated as spawn points for the first camp and the second camp. For example, as shown in FIG. 4, the plot where “Xiling Guan” is located serves as the spawn point for the first camp, while the plot where “Dongling Guan” is located serves as the spawn point for the second camp.

In the present embodiment, two plots are considered adjacent if they share a border. For example, as shown in FIG. 4, the plot where “San Guan” is located is adjacent to the plot where “Luoyang” is located, and the plot where “San Guan” is located is spaced from the plot where “Qutang Guan” is located by the plot where “Taohua Jin” is located or the plot where “Tong Guan” is located.

Taking FIG. 4 as an example, the plots occupied by the first camp are its friendly plots, and include the plots where “Xiling Guan”, “Liusha Kou”, “Wudu”, “Taohua Jin” and “Qutang Guan” are located. The second plots are the plots where “San Guan”, “Tong Guan”, “Changban” and “Yiling” are located. The first plots are the plots where “Luoyang”, “Baima Jin”, “Ruxu Kou”, “Xia Guan”, “Nanmen Guan” and “Dongling Guan” are located.

In the present embodiment, the second team may gradually occupy adjacent plots in a conventional step-by-step manner, while the first team is capable of capturing a plot occupied by the second camp that is closer to the spawn point for the second camp, expanding the strategic depth of the game and enhances the user's gaming experience.

In other words, after a user selects the first team of the first camp, in the first battle scene shown on the interface, the user can view the first plots that the first team, to which he/she belongs, can occupy and the second plot that the other second team can occupy. The first team to which the user belongs can occupy the first plot, allowing rewards for all users in the first camp to be determined based on the overall occupancy of plots by both teams. This necessitates the rational allocation of members between the first team and the second team during the occupation process of the first camp, thereby enhancing the game's playability and increasing user enjoyment.

In some embodiments, the second plot has at least one of a first attribute and a second attribute; wherein the second plot with the first attribute is a second plot already occupied by the second camp or the third camp, the second plot with the second attribute is an unoccupied (blank) plot, and the third camp is a non-player camp.

As shown in FIG. 4, plots occupied by the non-player camp may be plots occupied by AI, meaning that each team from both camps must engage in battle with virtual characters controlled by the AI when capturing these plots.

In some examples, the first plots may include the plots occupied by the second camp, the plots occupied by the non-player camp, and the unoccupied (blank) plots. Alternatively, the first plots may include only plots occupied by the second camp, which is not limited herein.

In some embodiments, the first battle scene also includes special plots that cannot be occupied by the first camp. These special plots include plots that serves as the spawn points for the second camp and plots that are under war-free protection.

Taking FIG. 4 as an example, the teams of the second camp may occupy the plots where “Liusha Kou”, “Wudu”, “Taohua Jin”, and “Qutang Guan” are located, among the friendly plots of the first camp. However, the plot where “Xiling Guan” is located is a special plot which cannot be occupied by the teams of the second camp.

Taking FIG. 4 as an example, if the first camp is under war-free protection, the plots of the first camp that are under war-free protection cannot be occupied by the teams of the second camp.

Continuing to take FIG. 4 as an example, the plots under war-free protection are the plots where “Xiling Guan”, “Liusha Kou” and “Wudu” are located. This allows the teams of the second camp to occupy the plots where “Taohua Jin” and “Qutang Guan” are located.

In other words, by setting the plot protection for spawn points and war-free protection, on one hand, it is possible to effectively reduce the situation that one camp loses all its occupied plots too quickly, which could prematurely end the game. On the other hand, it is possible to enhance the experience for novice players.

In some embodiments, the first battle scene also shows plot information about each of the first plot and the second plot; wherein the plot information comprises resource information and building information; wherein the resource information comprises a resource type and a resource quantity set for a plot; and the building information comprises a building level and a building name set for a plot.

Taking FIG. 4 as an example, the plot where “Liusha Kou” is located has resource types of “Iron Mine”, “Wood” and “Credits”, the resource quantity corresponding to “Iron Mine” is “+10/min”, the resource quantity corresponding to “Wood” is “+20/min”, and the resource quantity corresponding to “Credits” is “+50/min”. The building name of the plot where the “Liusha Kou” is located is “Liusha Kou”, and the building level is Level 5.

In other words, by displaying the plot information of the first plots and the second plots in the first battle scene, users are provided with a more intuitive understanding of the importance of each plot, facilitating decisions on which plots to prioritize or abandon. This further enhances the user's gaming experience.

### Second Embodiment

In the present embodiment, to facilitate the user in confirming the first plot that needs to be attacked, after the first team is instructed to attack one of the first plots, this first plot may be distinctively displayed to the user, enabling the user to quickly join the battle for this first plot.

In these embodiments, with respect to the first embodiment, the method further includes the following steps S230 to S240 after the step S220:
Step S230: according to a first plot that the first team is instructed to attack, the first battle scene displaying the instructed first plot as an attack target of the user.

In the present embodiment, the first plot that the first team is instructed to attack may be instructed by the administrator of the first team, may be randomly instructed by the system, or may be decided by a vote among team members of the first team, etc., which is not limited herein.

In the present embodiment, a specific plot can be displayed as an attack target in various ways. For example, prompt information indicating that the instructed first plot is the attack target is shown in the first battle scene; for another example, changes to the color, the pattern, and the like on the instructed first plot is shown in the first battle scene; for another example, as shown in FIG. 4, the attack marker D1 is shown in the first battle scene to indicate that the plot where the “Ruxu Kou” is located is the attack target.
Step S240: according to a battle joining operation of the user directed at the attack target, showing on the interface a second battle scene where the first team engages in battle with at least one third team from a second camp.

In the present embodiment, the first battle scene and the second battle scene are different scenarios, and the second battle scene may be a scenario in which the virtual characters controlled by the members of the first team battle against those controlled by the members of the third team.

In the present embodiment, the battle joining operation of the user directed at the attack target may be may be, for example, clicking on the attack marker D1 as shown in FIG. 4, or may be clicking on the control indicating agreement to attack in the confirmation window that pops up on the interface when the first team initiates an attack to the instructed first plot.

In the present embodiment, the second camp may deploy a defensive virtual character

on the instructed first plot. This virtual character may be one controlled by a member of the third team, a mirror virtual character of a specific member selected by the second camp, or a virtual character with zero combat power, which is not limited herein. If a user occupies a first plot defended by a virtual character with zero combat power, it is possible to directly display that the user has successfully occupied the first plot.

### Third Embodiment

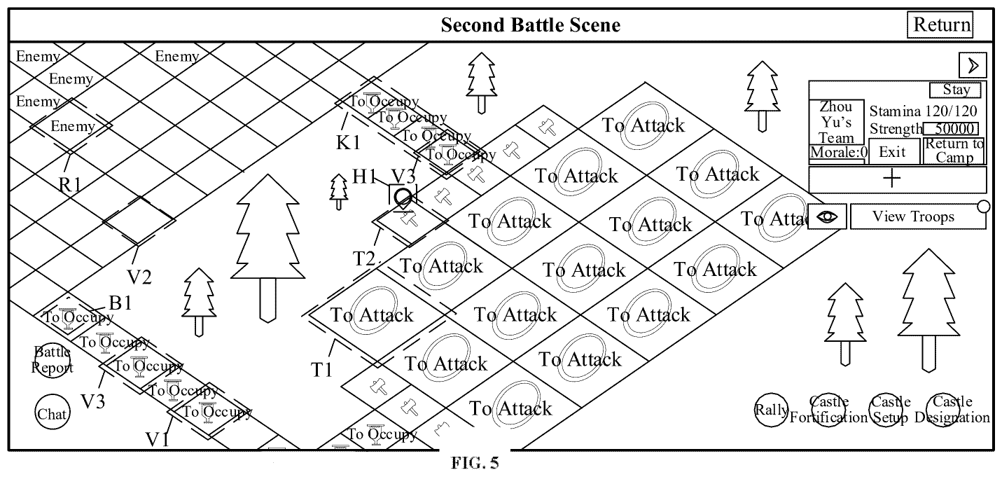

FIG. 5 illustrates a schematic diagram of the second battle scene according to some embodiments.

Taking FIG. 5 as an example, in this second battle scene, grid plots T1 and T2 are first grid plots designated for occupation by the first team, and grid plot R1 is a second grid plot occupied by the second camp.

In the present embodiment, the second grid plots occupied by the second camp can either be grid plots occupied by the same enemy team within the second camp or grid plots occupied by different enemy teams within the second camp, which is not limited herein.

In the present embodiment, the user performs a deployment operation on selected first grid plots to have them occupied by the first virtual character the user controls. This deployment operation involves the user controlling the first virtual character to execute corresponding actions on the selected first grid plot after choosing it. For example, these actions may include moving the first virtual character to the first grid plot or the first virtual character constructing different buildings on the first grid plot, which is not limited herein.

Taking FIG. 5 as an example, after the user clicks on the grid plot T2, a deployment marker H1 appears above the grid plot T2. After the user clicks on deployment marker H1, a building deployment popup window is displayed on the interface, allowing the user to choose a building to deploy on the grid plot T2. Once the user confirms a specific building, the interface shows the user's first virtual character moving to the grid plot T2 and then performing the action of constructing the confirmed building on the grid plot T2.

In some examples, when the first virtual character controlled by the user moves to the selected first grid plot or performs corresponding actions on it, the selected first grid plot is shown as being occupied by the user's own alliance.

In some embodiments, after the first virtual character occupies the selected first grid plot, the first grid plot possesses a first attribute and/or a second attribute; wherein the first attribute includes recovering movement power and combat power of the first virtual character; the second attribute includes weakening the movement power and combat power of the second virtual character attempting to capture the first grid plot; wherein the second virtual character belongs to the second camp.

In the present embodiment, the second virtual character from the second camp is a virtual character controlled by members of a specific team or multiple teams within the second camp. The second virtual character may be singular or plural, which is not limited herein.

In some examples, to enhance game rationality, in the second battle scene, the first grid plots with the first attribute are positioned farther away from the second grid plots compared to the first grid plots with the second attribute.

Taking FIG. 5 as an example, if the selected first grid plot is T1 and it is already occupied by the first virtual character, the user can build a building of the first type on T1, allowing the first virtual character of the user to recover its movement power and combat power in that building. If the selected first grid plot is T2 and it is already occupied by the first virtual character, the user builds a building of the second type on T2, such that the second virtual character may be weakened in movement power and combat power when capturing the building of the second type.

In other words, by setting different attributes for the first grid plots, it is possible to enrich the gameplay and improve the user's enjoyment.

In some embodiments, the second battle scene also includes a narrow lane arranged between the first grid plot and the second grid plot; wherein, the narrow lane consists of third grid plots, and the number of third grid plots in the width of the narrow lane is less than or equal to a second preset quantity; wherein, the width direction of the lane is perpendicular to the attack direction of the first team.

As shown in FIG. 5, the third grid plots may be a grid plot V1, a grid plot V2, and a grid plot V3. The narrow lane is composed of multiple grid plots V1, wherein the narrow lane K1 consists of four grid plots V1, and the number of the third grid plots in the width direction of the narrow lane K1 is 1.

In the present embodiment, the second preset quantity may be one or more, which is not limited herein.

In some examples, to further enrich the gameplay, the second preset quantity may be set to be fewer than the number of members in the first team, making it impossible for the members of the first team to simultaneously occupy all the third grid plots in the narrow lane.

In some embodiments, to aid the user in visually identifying the narrow lane, the third grid plots within the narrow lane may be shown distinguished from other third grid plots. Taking FIG. 5 as an example, the third grid plots serving as the narrow lane may show a “To Occupy” marker B1, while other third grid plots may appear as blank grid plots.

### Fourth Embodiment

In the present embodiment, to assist the users in confirming the plots they intend to capture, in the first battle scene, the first plot and the second plot may be shown separately so that the users can distinguish different plots.

In these embodiments, with respect to the above second embodiment, the method further comprises the following steps S250 and S260 after the above step S240:
Step S250: according to the first team being determined as a winner in the second battle scene, determining that the first team has occupied the first plot which was the attack target.

In the present embodiment, the second battle scene may be a scene where virtual characters controlled by each member of the first team battles against virtual characters controlled by each member of the third team.

In the present embodiment, the virtual characters controlled by each member of the first team defeats the virtual characters controlled by each member of the third team, and then the first team is the winner.
Step S260: in the first battle scene, providing an exclusive designation for the first plot now occupied by the first team.

In some embodiments, the exclusive designation can distinctively show that the first plot has been occupied by the first team. The exclusive designation can include, for example, an exclusive color, an exclusive pattern, or an exclusive text on the first plot, which is not limited herein.

Taking FIG. 4 as an example, for a plot already occupied by the first camp, “-first camp” may be shown below the plot to indicate that the plot is occupied by the first camp. For a plot already occupied by the second camp, “-second camp” may be shown below the plot to indicate that the plot is occupied by the second camp. For the first plot occupied by the first camp, “Our Occupation, Within Second Camp Territory” may be shown below the plot, and the area where this first plot is located is shown as a shaded area, so that the shaded area is used as an exclusive designation to indicate that the plot is now occupied by the first camp.

### Fifth Embodiment

In the present embodiment, to facilitate the user in monitoring the battle between the second team of the first camp and the second camp, the first battle scene may show the second plot occupied by the second team of the first camp.

In these embodiments, with respect to the above first embodiment, the method further comprises the following steps S2201 and S2202 after the above step S220
Step S2201: displaying a battle result of the second team attacking a second plot with the first attribute;

In the present embodiment, the battle result can be either the second team being the winner or the second team being the loser. In addition, in the first battle scene, the second plot where the battle result is that the second team is the loser remains displayed as occupied by the second camp.
Step S2202: if the battle result indicates that the second team has won, displaying the second plot as now occupied by the first camp.

Taking FIG. 4 as an example, the second team attacks the plot where “Tong Guan” is located, and the battle result of the second team attacking the plot where “Tong Guan” is located is that the second team has won. In the first battle scene, the “-second camp” displayed below the plot where “Tong Guan” is located is updated to “-first camp”.

### Sixth Embodiment

In the present embodiment, to facilitate the user in monitoring the battle between the second team of the first camp and the second camp, the first battle scene may show the second plot occupied by the third team of the second camp.

In these embodiments, with respect to the above first embodiment, the method further comprises the following steps S2203 and S2204 after the above step S220
Step S2203: displaying a battle result of a third team from the second camp attacking a second plot that is already occupied by the first camp.

In the present embodiment, the battle result can be either the third team being the winner or the third team being the loser. In addition, in the first battle scene, the second plot where the battle result is that the third team is the loser remains displayed as occupied by the first camp.
Step S2204: if the battle result indicates that the third team has won, displaying the second plot as now occupied by the second camp.

Taking FIG. 4 as an example, the third team attacks the plot where “Qutang Guan” is located, and the battle result of the third team attacking the plot where “Qutang Guan” is located is that the third team has won. In the first battle scene, the “-first camp” displayed below the plot where “Qutang Guan” is located is updated to “-second camp”.

### Apparatus Embodiment

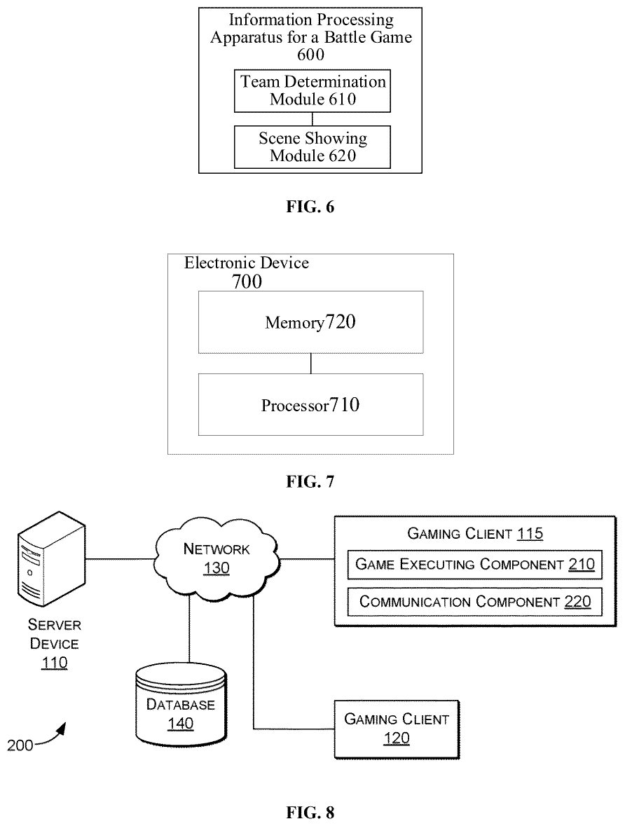

FIG. 6 shows a structural diagram of the configuration of an information processing apparatus for a battle game according to an embodiment of the present disclosure. As shown in FIG. 6, the information processing apparatus for a battle game 600 includes a team determination module 610 and a scene showing module 620.

The team determination module 610 is configured for determining a first team to which a user belongs according to a team selection operation of the user in a first camp to which the user belongs; wherein the first camp comprises both the first team and a second team which correspond to different battle configurations;

The scene showing module 620 is configured for showing on an interface a first battle scene that the user enters; wherein the first battle scene comprises a first plot which can be occupied by the first team and a second plot which can be occupied by the second team, the second plot being adjacent to a friendly plot, and the first plot being spaced from the friendly plot by at least one plot; wherein the friendly plot is a plot occupied by the first camp.

In some embodiments, the information processing apparatus 600 for a battle game further includes an attack displaying module, which is configured for: according to a first plot that the first team is instructed to attack, the first battle scene displaying the instructed first plot as an attack target of the user; according to a battle joining operation of the user directed at the attack target, showing on the interface a second battle scene where the first team engages in battle with at least one third team from a second camp.

In some embodiments, the information processing apparatus 600 for a battle game further includes an occupation designating module, which is configured for according to the first team being determined as a winner in the second battle scene, determining that the first team has occupied the first plot which was the attack target; and in the first battle scene, providing an exclusive designation for the first plot now occupied by the first team.

In some embodiments, the information processing apparatus 600 for a battle game further includes a friendly occupation displaying module, which is configured for displaying a battle result of the second team attacking a second plot with a first attribute, and if the battle result indicates that the second team has won, displaying the second plot as now occupied by the first camp.

In some embodiments, the information processing apparatus 600 for a battle game further includes an enemy occupation displaying module, which is configured for displaying a battle result of a third team from the second camp attacking a second plot that is already occupied by the first camp, and if the battle result indicates that the third team has won, displaying the second plot as now occupied by the second camp.

### Device Embodiment

FIG. 7 illustrates a schematic diagram of the hardware structure of the electronic device according to some embodiments. As shown in FIG. 7, the electronic device 700 includes a processor 710 and a memory 720, the memory 720 is configured for storing a computer program, and the computer program is used to control the processor 710 to operate, so as to control the electronic device 700 to perform the information processing method for a battle game according to any embodiment of the present disclosure.

Embodiments of the present disclosure also provide a computer-readable storage medium storing a computer program that, when executed by a processor, implements the information processing method for a battle game according to any embodiment of the present disclosure.

Turning now to FIG. 8, a schematic depiction is provided illustrating one exemplary operating environment 200 of which an embodiment of the present disclosure can be employed. It should be understood that this and other arrangements described herein are set forth only as examples. Other arrangements and elements (e.g., machines, interfaces, functions, orders, groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The operating environment 200 of FIG. 8 includes a server device 110 that provides a service to one or more client devices, such as gaming clients 115,120, for instructing game play and/or settings in a virtual gaming environment over a network 130, such as the Internet. The gaming clients 115,120 may implement a computerized system for providing information processing in a battle game. In some embodiments, the gaming clients 115,120 may be mobile electronic devices having touchscreens thereon, such as smart phones, tablets, or laptop computers. The server device 110 and the gaming clients 115,120 may communicate in a wired or wireless manner over the network 130.

In some embodiments, the server device 110 is coupled, directly or indirectly, to a database 140 for facilitating the storage and querying of records corresponding to a plurality of game play instructions, actions, objects (e.g., virtual game pieces/characters, weapons, buildings, etc.), maps, and/or settings. The database 140 includes, among other things, a relational database or similar storage structure accessible by the server device 110. In accordance with embodiments described herein, the database 140 stores a plurality of records that each corresponds to game play instructions, actions, objects, maps, and/or settings.

The server device 110 includes a gaming server accessible by any of the gaming clients 115,120 and/or a data server for supporting an application of any of the gaming clients 115,120, over the network 130. The gaming server can support any type of application, including those that facilitate live game play. The server device 110 can further determine relationships (e.g., teams) between the gaming clients 115,120. In various embodiments, the server device 110 communicates actions commanded via one or more of the gaming clients 115,120, to another one or more of the gaming clients 115,120 for presentation thereon via user interfaces or the like, as later described herein.

Network 130 may be wired, wireless, or both. Network 130 may include multiple networks, or a network of networks, but is shown in simple form so as not to obscure aspects of the present disclosure. By way of example, network 130 can include one or more wide area networks (WANs), one or more local area networks (LANs), one or more public networks, such as the Internet, one or more private networks, and/or one or more telecommunications networks. Where network 130 includes a wireless telecommunications network, components such as a base station, a communications tower, or even access points (as well as other components) may provide wireless connectivity. Networking environments are commonplace in enterprise-wide computer networks, intranets, and the Internet. Accordingly, network 130 is not described in significant detail.

In accordance with embodiments of the present disclosure, the server device 110 or the gaming clients 115, 120 can each be a computing device that is capable of accessing the Internet, such as the World Wide Web, and/or a telecommunications network. Either one of the server device 110 or the gaming clients 115, 120 might take on a variety of forms, such as a personal computer (PC), a laptop computer, a mobile phone, a tablet computer, a wearable computer, a personal digital assistant (PDA), an MP3 player, a global positioning system (GPS) device, a video player, a handheld communications device, a smartphone, a smart watch, a workstation, any combination of these delineated devices, or any other suitable device.

It should be understood that any number of the aforementioned devices may be employed in operating environment 200 within the scope of the present disclosure. Each may comprise a single device or multiple devices cooperating in a distributed environment. Additionally, other components not shown may also be included within the distributed environment. It should further be understood that operating environment 200 shown in FIG. 8 is an example of one suitable computing system architecture. Each of the servers, gaming clients, networks, and databases shown in FIG. 8 may be implemented via a computing device, such as computing device 600. The components may communicate with each other via network 130.

FIG. 8 also depicts operational modules of an exemplary one of the gaming clients, specifically gaming client 115, in accordance with some embodiments of the present disclosure. It is noted that the depicted implementation is merely exemplary, and not intended to be limiting in any way, as each component can be arranged in various configurations, spread across a number of computing devices, combined with other components or one another, arranged to communicate over a network, or any combination of the foregoing including others not mentioned. For example, each of the operational modules may comprise a combination of hardware components and/or computer instructions stored on computer-readable media or a memory and executable on a processor thereof.

As depicted in FIG. 8, the operational modules of the gaming client 115 may comprise a game executing component 210 and a communication component 220. The game executing component 210 can be configured for executing a battle game as described above. The communication component 220 can be configured for network communications between the gaming client 115, the gaming client 120, and/or the server device 110 via network 130.

The various embodiments described in this specification are presented in a progressive manner. The same and similar parts between each embodiment can refer to each other, and each embodiment focuses on the differences from other embodiments. Especially for the embodiment of the device and the apparatus, because they are basically similar to the method embodiment, the description is relatively simple, and the relevant part can be referred to the part of the method embodiment.

The specific embodiments of this specification have been described above. Other embodiments fall within the scope of the appended claims. In some cases, the actions or steps recorded in the claims can be executed in an order different from that of the embodiments and still achieve the desired results. Additionally, processes depicted in the diagrams do not necessarily require the particular order or continuous sequence shown to achieve the desired outcome. In certain implementations, multitasking and parallel processing are also possible or may be advantageous.

Embodiments of this specification can be devices, methods, and/or computer program products. A computer program product may comprise a computer-readable storage medium having computer-readable program instructions carried thereon for enabling processors to implement various aspects of the embodiments described in this specification.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium comprises the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of embodiments of this specification may be assembler instructions, instruction-set-architecture (ISA) instructions, machine instructions, machine dependent instructions, microcode, firmware instructions, state-setting data, or either source code or object code written in any combination of one or more programming languages, comprising an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, comprising a local area network (LAN) or a wide area network (WAN), or the connection may be made to an external computer (for example, through the Internet using an Internet Service Provider). In some embodiments, electronic circuitry comprising, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of embodiments of this specification are described herein with reference to flowchart illustrations and/or block diagrams of methods, apparatus (systems), and computer program products according to embodiments of this specification. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture comprising instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of this specification. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. It is well-known to a member skilled in the art that the implementations of using hardware, using software or using the combination of software and hardware can be equivalent.

Embodiments of this specification have been presented for illustrative purposes, and are not intended to be exhaustive or limited to the disclosed embodiments. Various modifications and changes will be apparent to those skilled in the art without departing from the scope and spirit of the disclosed embodiments. The terminology used herein is chosen to best explain the principles of the embodiments, their practical applications or technical improvements they offer over existing technologies, thereby enabling others of ordinary skill in the art to understand the embodiments disclosed herein.

1. An information processing method for implementation by a device that executes a battle game, comprising:
determining, by a processor, a first team to which a first user belongs according to a team selection operation of the user in a first camp to which the first user belongs; wherein the first camp comprises both the first team and a second team which correspond to different battle configurations, and the first camp comprises a plurality of users; and
generating, by the processor, a first battle scene for displaying on an interface; wherein the first battle scene comprises a first plot which is configured to be occupied by the first team and a second plot which is configured to be occupied by the second team, the second plot being adjacent to a friendly plot, and the first plot being spaced from the friendly plot by at least an intermediate plot; wherein the friendly plot is a plot occupied by the first camp, and
displaying, on the interface, the first battle scene, where the users belonging to the first team control virtual characters to engage in actions to attack and occupy the first plot according to predefined game instructions.

2. The method according to claim 1, wherein after the displaying, on the interface, the first battle scene, the method further comprises:
according to a first plot, instructing the first team to attack, such that the first battle scene includes the instructed first plot as an attack target of the user; and
according to a battle, adding an operation of the user directing the attack target, by the processor, and
displaying, on the interface, a second battle scene where the first team engages in battle with at least one third team from a second camp.

3. The method according to claim 2, wherein after the displaying, on the interface, a second battle scene where the first team engages in battle with at least one third team from a second camp, the method further comprises:
according to a result where the first team is determined as a winner in the second battle scene, instructing, by the processor, that the first team has occupied the first plot which was the attack target; and
providing, by the processor, an exclusive designation for the first plot now occupied by the first team, in the first battle scene.

4. The method according to claim 1, wherein after the displaying, on the interface, the first battle scene, the method further comprises:
displaying, on the interface, a battle result of the second team attacking a second plot; and
displaying, on the interface, the second plot as now occupied by the first camp, if the battle result indicates that the second team has won.

5. The method according to claim 1, wherein after the displaying, on the interface, the first battle scene, the method further comprises:
displaying, on the interface, a battle result of a third team from the second camp attacking a second plot that is already occupied by the first camp; and
displaying, on the interface, the second plot as now occupied by the second camp, if the battle result indicates that the third team has won.

6. The method according to claim 1, wherein the first battle scene also comprises restricted plots that are not be occupied by the first camp, and the restricted plots comprise a first restricted plot that serves as a spawn point for the second camp and a second restricted plot that is under a war-free protection.

7. The method according to claim 1, wherein the first battle scene shows plot information about each of the first plot and the second plot; wherein the plot information comprises resource information and building information;
wherein the resource information comprises a plot resource type and a plot resource quantity set; and the building information comprises a plot building level and a plot building name set.

8. A computerized system for providing information processing in a battle game, comprising:
a interface display,
a memory, configured for storing a computer program; and
processor, configured for executing an information processing method according to claim 1, under control of the computer program.

9. The system according to claim 8, wherein after the displaying, on the interface, the first battle scene, the method further comprises:
according to a first plot, instructing the first team to attack, such that the first battle scene displays the instructed first plot as an attack target of the user; and
according to a battle, adding an operation of the user directing the attack target, by the processor, and
displaying, on the interface, a second battle scene where the first team engages in battle with at least one third team from a second camp.

10. The system according to claim 9, wherein the operations further comprises, wherein after the displaying, on the interface, a second battle scene where the first team engages in battle with at least one third team from a second camp, the method further comprises:
according to a result where the first team is determined as a winner in the second battle scene, instructing, by the processor, that the first team has occupied the first plot which was the attack target; and
providing, by the processor, an exclusive designation for the first plot now occupied by the first team, in the first battle scene.

11. The system according to claim 8, wherein after the displaying, on the interface, the first battle scene, the method further comprises:
displaying, on the interface, a battle result of the second team attacking a second plot; and
displaying, on the interface, the second plot as now occupied by the first camp, if the battle result indicates that the second team has won.

12. The system according to claim 8, after the displaying, on the interface, the first battle scene, the method further comprises:
displaying, on the interface, a battle result of a third team from the second camp attacking a second plot that is already occupied by the first camp; and
displaying, on the interface, the second plot as now occupied by the second camp, if the battle result indicates that the third team has won.

13. The system according to claim 8, wherein the first battle scene furthercomprises restricted plots that are not be occupied by the first camp, and the restricted plots comprise a first restricted plot that serves as a spawn point for the second camp and a second restricted plot that is under a war-free protection.

14. The system according to claim 8, wherein the first battle scene further comprises plot information about each of the first plot and the second plot; wherein the plot information comprises resource information and building information;
wherein the resource information comprises a plot resource type and a plot resource quantity set; and the building information comprises a plot building level and a plot building name set.

15. A non-transitory computer-readable medium storing instructions, when executed by a processor, cause the processor to perform a method for information processing in a battle game according to claim 1.

16. The non-transitory computer-readable medium according to claim 15 storing instructions, when executed by a processor, cause the processor to perform a method for information processing in a battle game, wherein after the displaying, on the interface, the first battle scene, the method further comprises:
according to a first plot, instructing the first team to attack, such that the first battle scene displays the instructed first plot as an attack target of the user; and
according to a battle, adding an operation of the user directing the attack target, by the processor, and
displaying, on the interface, a second battle scene where the first team engages in battle with at least one third team from a second camp.

17. The non-transitory computer-readable medium according to claim 16 storing instructions, when executed by a processor, cause the processor to perform a method for information processing in a battle game, wherein after the displaying, on the interface, a second battle scene where the first team engages in battle with at least one third team from a second camp, the method further comprises:
according to a result where the first team is determined as a winner in the second battle scene, instructing, by the processor, that the first team has occupied the first plot which was the attack target; and
providing, by the processor, an exclusive designation for the first plot now occupied by the first team, in the first battle scene.

18. The non-transitory computer-readable medium according to claim 15 storing instructions, when executed by a processor, cause the processor to perform a method for information processing in a battle game, wherein after the displaying, on the interface, the first battle interface, the method further comprises:
displaying, on the interface, a battle result of the second team attacking a second plot; and
displaying, on the interface, the second plot as now occupied by the first camp, if the battle result indicates that the second team has won.

19. The non-transitory computer-readable medium according to claim 15 storing instructions, when executed by a processor, cause the processor to perform a method for information processing in a battle game, wherein after the displaying, on the interface, the first battle scene, the method further comprises:
displaying, on the interface, a battle result of a third team from the second camp attacking a second plot that is already occupied by the first camp; and
displaying, on the interface, the second plot as now occupied by the second camp, if the battle result indicates that the third team has won.

20. The non-transitory computer-readable medium according to claim 15 storing instructions, when executed by a processor, cause the processor to perform a method for information processing in a battle game,
wherein the first battle scene also comprises restricted plots that are not be occupied by the first camp, and the restricted plots comprise a first restricted plot that serves as a spawn point for the second camp and a second restricted plot that is under a war-free protection;
wherein the plot information comprises resource information and building information;
wherein the resource information comprises a plot resource type and a plot resource quantity set; and the building information comprises a plot building level and a plot building name set.
